(19) United States
(12) Patent Application Publication
(10) Pub. No.: US 2016/0240957 A1
(43) Pub. Date: Aug. 18, 2016

(54) SEALED ELECTRICAL CABLE CONNECTOR

(71) Applicant: DELPHI TECHNOLOGIES, INC., TROY, MI (US)

(72) Inventors: MARTIN LUDWIG, WUPPERTAL (DE); MICHAEL HORNUNG, WUPPERTAL (DE)

(21) Appl. No.: 15/041,302

(22) Filed: Feb. 11, 2016

(30) Foreign Application Priority Data
Feb. 12, 2015 (EP) 15154927.6

(51) Int. Cl. H01R 13/52; H01R 43/20; H01R 13/502

(52) U.S. Cl. CPC H01R 13/5208; H01R 13/502; H01R 43/20; H01R 2107/00

(57) ABSTRACT

An electrical connector comprising a first connector housing having a first side configured for connection to a complementary connector, and a second side, with at least one opening expanding in the insertion direction to a cavity, at least a second connector housing which can be held in the cavity of the first connector housing, a seal that is attachable to the second side of the first the connector housing, a seal holder that holds the seal at the second side of the first connector housing, wherein the seal comprises at least one opening aligned with the opening of the first connector housing in the insertion direction, and wherein the opening in the seal is smaller than the opening in the first connector housing.

### CROSS-REFERENCE TO RELATED APPLICATION

This application claims the benefit under 35 U.S.C. §119(a) of Patent Application No. 15154927.6 filed in the European Patent Office (EPO) on Feb. 12, 2015, the entire disclosure of which is hereby incorporated by reference.

### TECHNICAL FIELD OF THE INVENTION

The invention relates to a sealed electrical cable connector for vehicles, in particular for use with in-vehicle networks, and a method for manufacturing a network cable with such a connector.

### BACKGROUND OF THE INVENTION

In automotive engineering, networks have become essential that interconnect intelligent nodes. With the use of networks and intelligent nodes, it has become possible to economize on signal lines in vehicles. At the same time, there is an increase in safety and comfort. However, in networks for data transmission, the technical characteristics need to be considered in comparison to conventional wiring of vehicles. This means that lines need to be used configured to the signals to be transmitted. Thereto, coaxial cables, fiber optics, or so-called twisted pair cables are used, known from computer systems. Twisted pair cables are cables having twisted pairs of conductors that are shielded or unshielded. The conductor pairs usually have a second common isolation layer giving the cable more mechanical stability. In practice, twisted pair cables have proved to be particularly practical. The number of nodes in modern vehicles is continuously increasing with the development of new features. Since space in vehicles is limited and weight also is of importance, miniaturized connector systems are used. Miniaturized connector systems are relatively difficult to process in manufacturing of vehicles. A certain degree of robustness is required during assembly. At the same time, there is an increase in data rates that need to be transmitted over the networks. This results in additional challenges that must be mastered. The nodes, connectors and cables need to be configured to each other to avoid errors in signaling. Thereto, it is necessary to provide the conductors of the twisted pair cables as close together as possible, from the source to the target. A known solution is to construct the connectors in a modular way and to provide the cables for the networks as separate conductor sets. As a result, the handling can be facilitated in manufacturing the cable set, since the network connection cables can be pre-assembled separately. The network connection cables are supplied complete with connectors at their ends and integrated into connector housings of the cable set.

In vehicles, sets of cables need to be sealed against moisture and debris. Examples are seen in EP1024557 and WO2013031088. However, in this case, the modularization has a negative effect. The effort necessary for sealing increases. The sealing of modular connector systems, notably with high-speed network connections, presents the developers with major problems.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

An electrical connector is presented herein. The electrical connector comprising a first connector housing having a first side configured for connection to a complementary connector, and a second side with at least one opening expanding in the insertion direction to a cavity. At least a second connector housing which can be held in the at least one cavity of the first connector housing. A seal that is attachable to the second side of the first connector housing, a seal holder that holds the seal at the second side of the first connector housing, wherein the seal comprises at least one opening aligned with the opening of the first connector housing in insertion direction. Wherein the opening in the seal is smaller than the opening in the first connector housing.

A method for manufacturing a connection line for a network is presented herein. The method comprises the steps of:
a) providing a first connector housing;
b) attaching a seal to the second side of the first connector housing;
c) providing a second connector housing with an electrically connected and mechanically attached network cable;
d) inserting the second connector housing through an opening in the seal into an opening of the first connector housing;
e) moving the second connector housing until the second connector housing is received and held in the cavity of the first housing;
f) attaching a seal holder to the second side of the first connector housing so that the seal is held on the first connector housing.

According to an embodiment, the second connector housing comprises a front face and side faces. The side faces extend from the front face contrary to the insertion direction, wherein the transition areas between the surfaces are rounded and/or chamfered. Upon insertion of an object with sharp corners into an opening of a resilient material, the material can readily tear. By rounding or chamfering the transition areas between the front and side faces, the sliding of the second connector through the opening of the seal is made possible without damaging the seal by sharp edges and corners. The rounded or chamfered side edges (transition areas parallel to insertion direction) prevent damage to the opening of the seal when inserting the second connector housing. When using a connector housing having a circular cross-section that requirement is dispensable. In the present embodiment, however, the orientation of the second connector housing in the first connector housing is important.

According to another embodiment, the front edges and the side edges (transition areas), sliding along the seal during insertion of the second connector housing through the opening of the seal, are rounded and/or chamfered. By removing sharp edges by means of chamfering or rounding, the risk of damage to the opening of the resilient seal is minimized when inserting the second connector housing. However, it is sufficient to de-sharpen only the areas of the second connector housing which come into contact with the seal when sliding through.

The seal may be integrally formed of a resilient material. With the use of an integrally formed seal, the manufacturing costs are reduced. In comparison to individual conductor sealing, the integrally formed seal is cheaper to produce and more cost-effective in assembly. Also, seal in layers may be used with which different passage geometries can be realized. The smaller second connector housings may be inserted through the resilient openings.

According to a yet another embodiment, the seal comprises recesses at its first side that faces the second side of the first connector and/or at its second side that faces the seal holder. The seal, which in this embodiment is made of silicone, has recesses at its first side. Depending on the design of the first housing, projections of the first connector housing may protrude into the recesses. These projections maintain the seal in the desired position. Thus, it is ensured that the openings of the seal are aligned with the openings of the first connector housing. However, the recesses may not be occupied by housing parts. The flexibility of the seal is improved when the silicone has space for expansion. The recesses at the second side of the seal also provide space for expansion of the material of the seal when a second connector housing is inserted through the opening. Since silicone is non-compressible, a possibility is provided to expand the openings without forcing the material toward the opening of the first connector housing.

According to an additional embodiment, the at least one opening in the seal is formed such that it sealingly surrounds a network cable. The size of the openings in the seal is determined according to the geometry of the second connector housing and the diameter of the network cable. The opening in the seal is dimensioned such that the second housing can slide through the opening without damage to the seal. Thereafter, the seal tightly surrounds the network cable.

The seal may comprise silicone or consist of silicone. The use of silicone has the advantage, among others, that during manufacture of silicone seal most often some oil remains on the seal, which facilitates the insertion of the second connector housings. With appropriately configured design, a silicone seal could be molded to the first housing. However, this embodiment is not further pursued here.

According to another embodiment, the seal holder is formed of several parts. The electrical connector is mounted in an order in which the seal holder is attached to the second side of the first connector housing in the last step of the procedure. At this point, several network cables project from the second side of the first connector housing, in particular with connectors receiving more than one second connector housing. Since the seal holder has a plurality of parts, the seal holder may be positioned around the network cables and the seal, even between the network cables, may be held at the second side of the first connector housing.

The parts of the seal holder may be movably connected with each other. The parts of the seal holder are connected with each other to improve the handling during assembly. The parts need not be collected to fit and cannot be easily lost. They may be connected to each other by means of film hinges, for example. The use is predefined by the position of the connection. The parts can be assembled only in a certain way, so that errors during assembly can be virtually ruled out.

One or more parts of the seal holder may have a recess perpendicular to the insertion direction. The seal holder may be arranged between network cables such that a network cable is received in the recesses. Another part of the seal holder is connected to the first part such that the network cable is completely surrounded by the seal holder. In particular with connectors with a plurality of second connector housings, this seal holder may be easily arranged and assembled between the network cables. The network cables do not need to be threaded through openings, which greatly facilitates the assembly. After the individual parts are connected to each other, they form a stable lid.

The seal holder may comprise projections in the insertion direction and/or contrary to the insertion direction. The projections of the seal holder, which project in insertion direction, are inserted into the recesses of the seal in the last step of the assembly of the seal holder. The projections occupy the space that the seal requires during insertion of the second connector housing to expand the opening. Thus, the opening of the seal cannot expand and peripherally abuts to the isolation of the twisted pair cable. This improves the sealing. The projections of the seal holder, which project from the second side of the first connector housing contrary to the insertion direction, have a mechanical stabilizing effect for the seal holder. The arrangement of the projections may be selected such that a water reservoir is formed when a jet of water splashes onto the seal holder. The water between the projections reduces the water pressure in the area between the seal and the isolation of the network cable.

In manufacture of the connection line, the second connector housing may be completely inserted through the opening in the seal. This facilitates the handling during assembly. These are very small connector systems which are difficult to handle in conventional manner.

According to another embodiment, the seal holder is first placed between the network cables and then the remaining parts are placed around the network cables. This creates a closed surface through which the network cables protrude. From the individual parts, a massive plate is formed that holds the seal at the housing and additionally seals the network cables.

According to yet another embodiment, the seal holder is arranged such that the projections of the seal holder protrude into the recesses of the seal. The projections displace the seal from the recesses and press the seal against the network cables. Thus, the sealing is improved and the seal is maintained in position.

### BRIEF DESCRIPTION OF THE SEVERAL VIEWS OF THE DRAWING

The present invention will now be described, by way of example with reference to the accompanying drawings, in which:

FIG. 1 shows a modular connector according to the prior art;

FIGS. 2a -2c show three views of the first housing of the connector;

FIGS. 3a -3c show three views of the second housing of the connector;

FIGS. 4a -4c show three views of the seal of the connector;

FIGS. 5a -5c show three views of the seal holder of the connector;

FIG. 6 shows a perspective view of the seal holder in the assembled state;

FIG. 7 shows an exploded view of the connector;

FIG. 8 shows a perspective view of the connector with open seal holder;

FIG. 9 shows a perspective view of the connector with closed seal holder;

FIG. 10 shows a perspective view of the connector with a seal holder attached to the first connector housing; and

FIG. 11 shows a cross-sectional view of the connector in the fully assembled state.

### DETAILED DESCRIPTION OF THE INVENTION

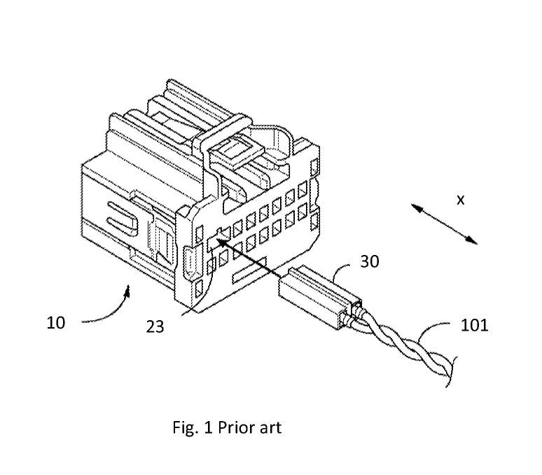

FIG. 1 shows a modular connector 10P according to the prior art. The connector has a first connector housing with chambers for receiving of contact portions attached to electrical lines. Also, the first connector housing has an opening 23P for receiving a second connector 30P to which a twisted pair cable 101P is mounted. This connector concept uses single conductor seals as a seal for the second connector 30P. However, the entire connector 10P is not sealed.

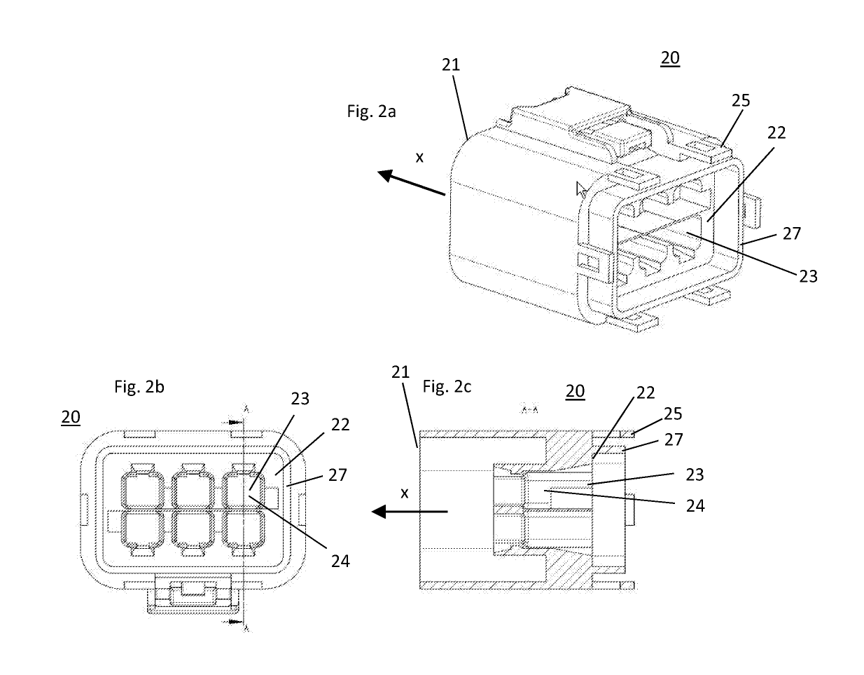

FIG. 2a shows a perspective view of a first connector housing 20 and a connector 10. The first connector housing 20 has a first side 21 which is configured to be connected with a complementary connector (not shown). The connector 10 is moved in insertion direction (x) to be connected to the complementary connector. The first connector housing 20 includes a second side 22. The second side 22 comprises openings 23. The openings 23 are configured for receiving further connector housings 30. Cavities 24 are provided between the first side 21 and the second side 22, in which the second connector housings 30 can be held. A collar 27 projects from the second side 22 contrary to the insertion direction x. The collar 27 surrounds the area in which the openings 23 are located. The surface of the second side 22 and the circumferential collar 27 form a receptacle for the seal 40. Lugs 25 project from the first connector housing 20 contrary to the insertion direction (x). They serve for fastening of the seal holder 50. FIG. 2b shows a view of the second side 22 of the first connector housing 20. A cross-sectional axis (A) extends perpendicularly through the first connector housing 20. FIG. 2c shows a sectional view of the first connector housing 20 along the cross-sectional axis (A).

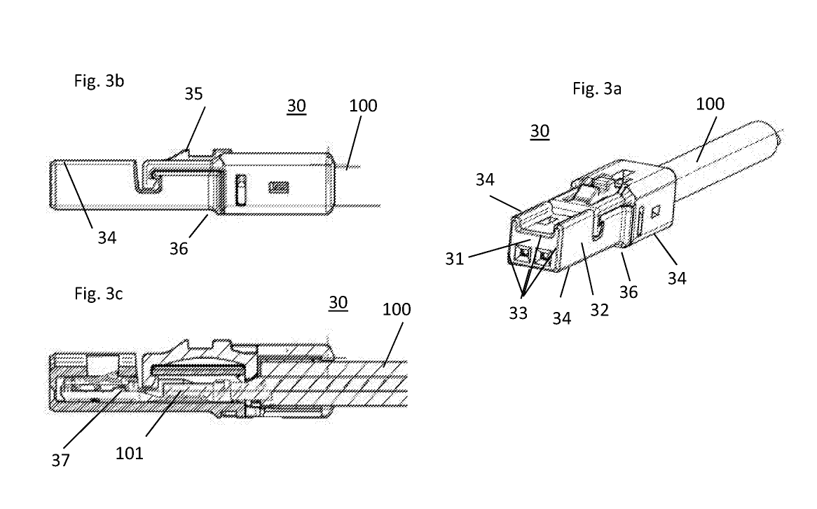

FIG. 3a shows a perspective view of the second connector housing 30 of the connector 10. The second connector housing 30 is configured such that it can be inserted into the cavity 24 of the first connector housing 20 and is held there. To be held in the cavity 24, a detent mechanism 35 is provided at both housings 20, 30. The second connector housing 30 is configured as a two-pole housing and has a substantially cuboid shape. The front part of the second connector housing 30, relative to the insertion direction (x), comprises chamfered transition areas 33 between the surfaces 31, 32. Thus, the circumferential transition area 33 surrounding the front surface 31 is de-sharpened. The angle between the front surface 31 and the side surfaces 32 of the second connector housing 30, which is opposite to the insertion direction x, is flattened by being spread to two edges. The circumferential transition area 33 could also be rounded. The transition areas 34 of the cuboid second connector housing 30 along the insertion axis (x) are also chamfered or rounded. FIG. 3b shows a side view of the second connector housing 30. The second connector housing 30 is shown here as a two-piece component, though it is immaterial. Furthermore, the second connector housing 30 comprises a chamfered transition area 36. The chamfered transition area 36 supports the sliding of the second connector housing 30 through the seal 40.

FIG. 3c shows a sectional view of the second connector housing 30 wherein the section is in insertion direction. Inside the second connector housing 30, a contact element 37 is shown having attached thereto a twisted pair cable 101. The twisted pair cable 101 has a further isolation layer as is common with network cables 100.

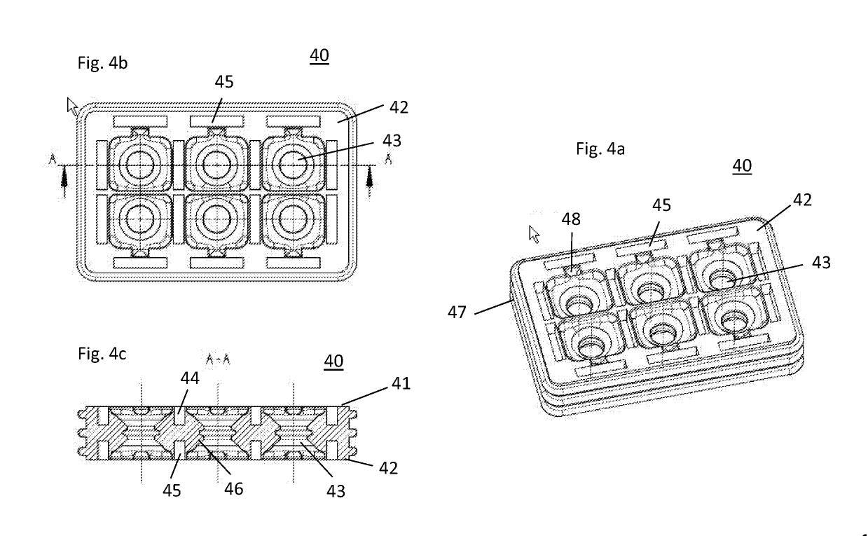

FIG. 4a shows a perspective view of the seal 40 of the connector 10. The seal 40 here is shown as an integrally-formed flat block sealing. Sealing lips 46, 47 are formed on the outer periphery and within the openings. The sealing lips 47 on the outer periphery cooperate with the inner surface of the collar 27 to seal the second side 22 of the first connector housing 20. The sealing lips 46 within the openings 43 are formed such that they cling to the network cables 100. At the first side 41 and the second side 42 of the seal 40, recesses 44, 45 are formed. The recesses 44, 45 serve as reservoir for the seal material during assembly of the connector 10. At the point at which one of the second connector housings 30 is inserted through the opening 43, the displaced seal material can flow into the recesses 44, 45 and the opening 43 may be easier to expand. A recess 48 at the upper edge of the opening 43 serves for alignment of the second connector housing 30 when being inserted through the seal 40. FIG. 4b shows a view of the second side 42 of the seal 40. The sectional axis (A) shows the sectional cut through the seal 40. FIG. 4c shows a sectional view of the seal 40.

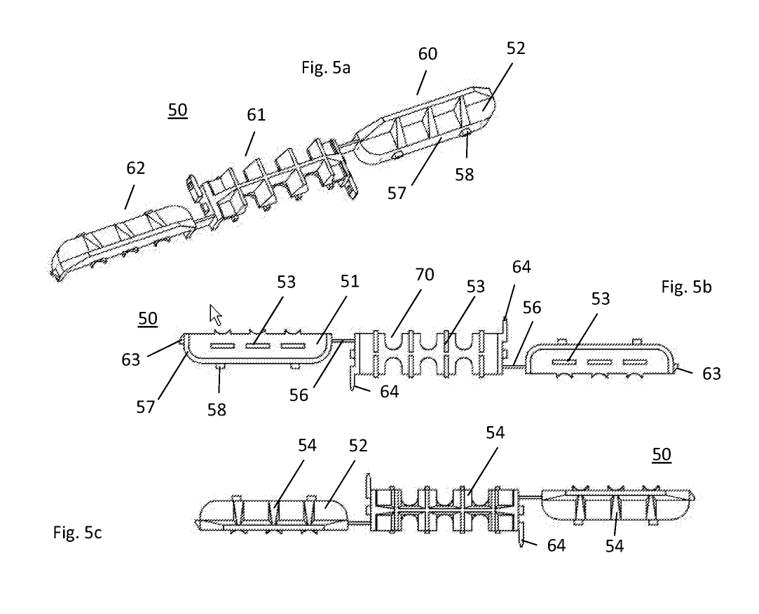

FIG. 5a shows a perspective view of the seal holder 50 of the connector 10. The seal holder 50 is formed in several parts. The individual parts 60, 61, 62 of the seal holder 50 here are held together by film hinges 56. The arrangement of the film hinges 56 results in a predetermined sequence of movements to assemble the seal holder 50. FIG. 5b shows the first side 51 of the seal holder 50. The seal holder 50 has projections 53, 54 on its first side 51 and second side 52. The projections 53 protruding from the first side 51 protrude into the recess 44, 45 of the seal 40 when in the assembled state. The seal holder 50 comprises recess 70 through which the network cable 100 may be passed through the seal holder 50. A detent mechanism 63, 64 is provided to hold together the parts 60, 61, 62 of the seal holder 50 after assembly. The detent mechanism 63, 64 includes a detent 63 and a closing tab 64 with which the detent 63 can engage. FIG. 5c shows the second side 52 of the seal holder 50. The second side 52 comprises projections 54 extending contrary to the insertion direction (x).

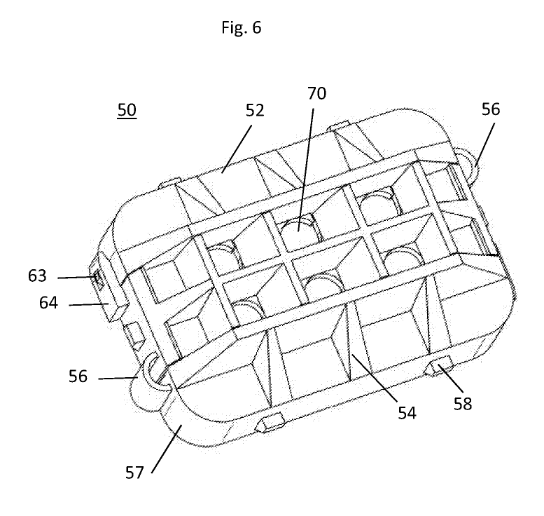

FIG. 6 shows the seal holder 50 in the assembled state. The detent mechanism 63, 64 and the hinges 56 hold together the parts 60, 61, 62 such that a lid-shaped structure is formed. The seal holder 50 comprises, at its edge, a circumferential collar 57 extending in the insertion direction x. Detents 58 are arranged on the outer side of the collar 57 with which the seal holder 50 can be fastened to the lugs 25 of the first connector housing 20.

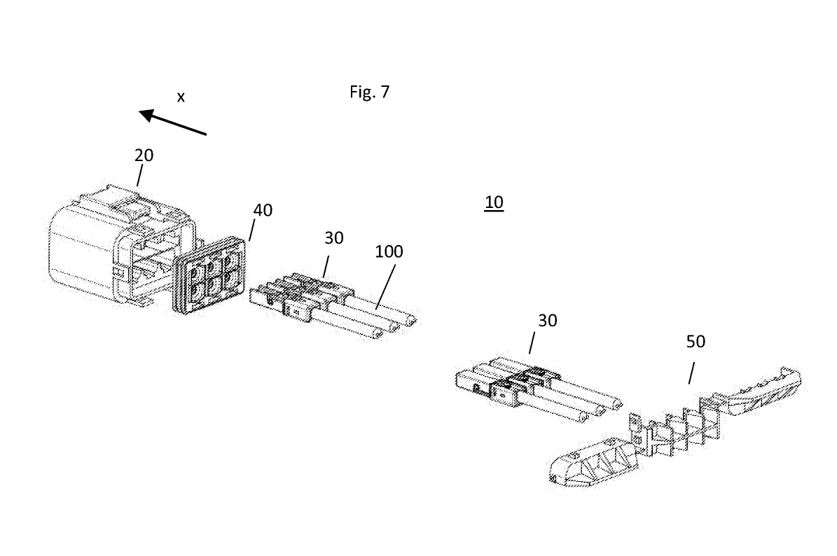

FIG. 7 shows an exploded view of the connector 10. This view illustrates the method for mounting the connector 10. The seal 40 is attached to the first connector housing 20. Then, the second connector housings 30 with attached network cables 100 are inserted through the seal 40 into the first connector housing 20. Thereafter, the seal holder 50 is arranged between the network cables 100, assembled into a lid-like structure and connected to the first connector housing 20.

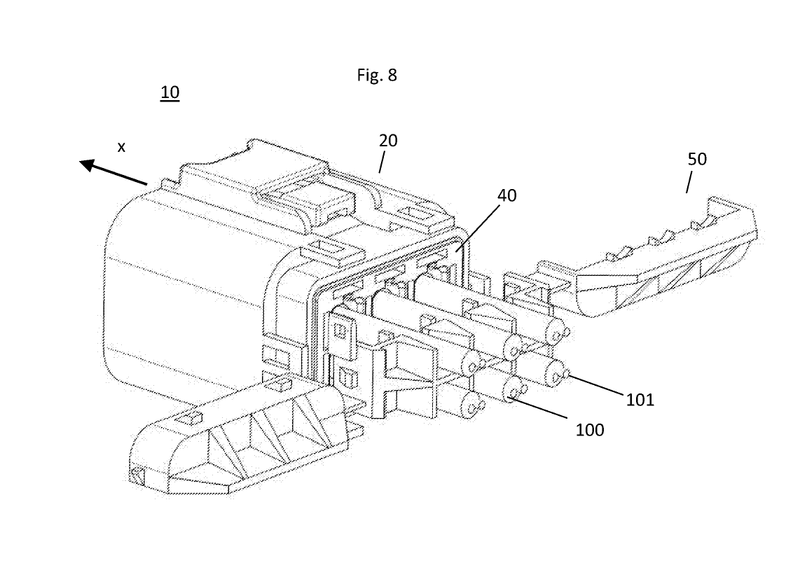

FIG. 8 shows an exploded view of the connector 10. The figure shows the connector 10 with the seal holder 50 arranged between the network cables 100. The seal holder 50 is not yet folded into its lid-like shape.

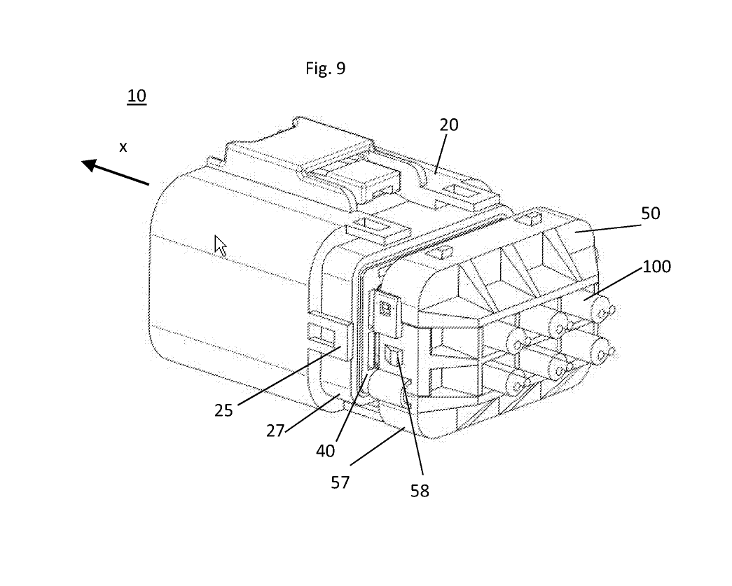

FIG. 9 shows an exploded view of the connector 10. The figure shows the connector 10 with the seal holder 50 arranged between the network cables 100. The seal holder 50 is folded into its lid-like shape. In the next assembly step, the seal holder 50 is moved in insertion direction x until the collar 57 of the seal holder 50 is pulled over the collar 27 of the first connector housing 20 and the detent 58 of the seal holder 50 is locked into the lug 25 of the first connector housing 20.

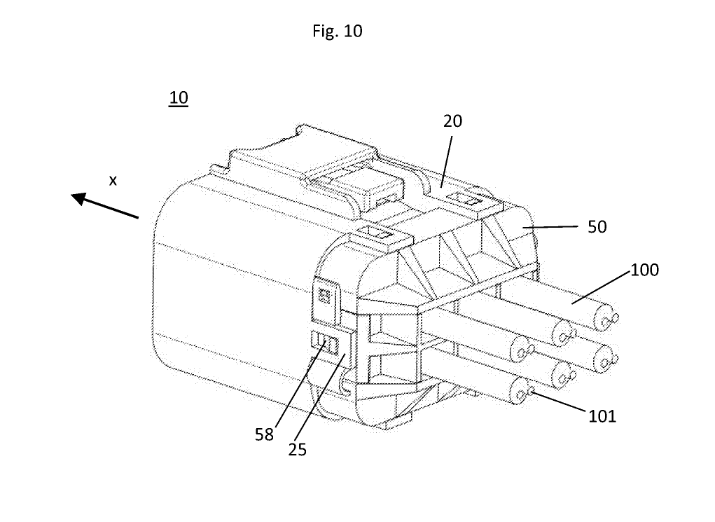

FIG. 10 shows a perspective view of the connector 10 in the assembled state. The network cables 100 protrude from the openings 23 of the first connector housing 20, through the opening 43 of the seal 40. The seal holder 50 is arranged between the network cables 100 and connected to the second side 22 of the first connector housing 20. The connection is made by means of a snap mechanism 25, 58.

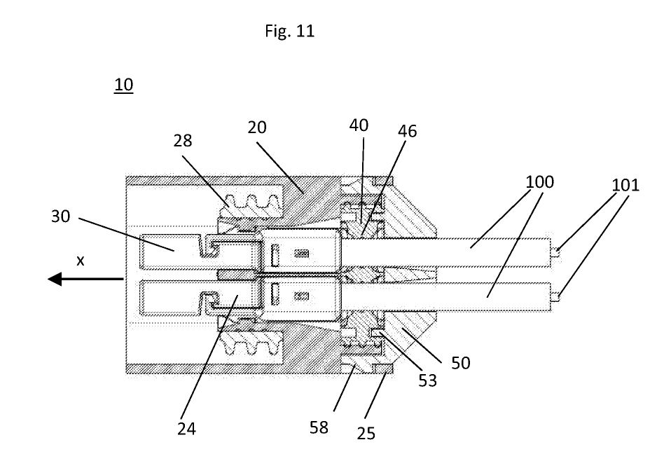

FIG. 11 shows a sectional view of the connector 10 in the assembled state. The second connector housing 30 is received and held in the cavity 24 of the first connector housing 20. The contact elements 37 in the second connector housing 30 are aligned in the insertion direction x and the conductors of the twisted pair cable 101 of the network cable 100 are connected to the contact elements 37. The seal 40 is in contact with the second side 22 of the first connector housing 20. The network cable 100 protrudes through the opening 43 of the seal 40. The seal holder 50 is connected to the first connector housing 20 by a snap mechanism 25, 58. The projections 53 of the seal holder 50 protrude into the recesses 45 of the seal 40 and hold the sealing lips 46 on the outer side of the network cable 100.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. An electrical connector, comprising:
a first connector housing having a first side configured for connection to a complementary connector and a second side, with an opening expanding in an insertion direction to a cavity,
a seal that is attachable to the second side of the first connector housing,
a seal holder that holds the seal at the second side of the first connector housing, wherein the seal comprises a seal opening aligned with the opening of the first connector housing in the insertion direction, and wherein the seal opening is smaller than the opening in the first connector housing; and
a second connector housing, which can be held in the cavity of the first connector housing.

2. The electrical connector according to claim 1, wherein the second connector housing comprises a front surface and side surfaces, wherein the side surfaces extend from the front surface contrary to the insertion direction and wherein transition areas between the surfaces are rounded.

3. The electrical connector according to claim 2, wherein the transition areas sliding along the seal during insertion of the second connector housing through the seal opening, are rounded.

4. The electrical connector according to claim 1, wherein the second connector housing comprises a front surface and side surfaces, wherein the side surfaces extend from the front surface contrary to the insertion direction and wherein transition areas between the surfaces are chamfered.

5. The electrical connector according to claim 2, wherein the transition areas sliding along the seal during insertion of the second connector housing through the seal opening, are chamfered.

6. The electrical connector according to claim 1, wherein the seal is integrally formed of a resilient material.

7. The electrical connector according to claim 1, wherein the seal comprises a recess at a first side that faces the second side of the first connector housing and at a second side that faces the seal holder.

8. The electrical connector according to claim 1, wherein the seal opening is formed such that it sealingly surrounds a network cable which extends through the opening.

9. The electrical connector according to claim 1, wherein the seal comprises silicone.

10. The electrical connector according to claim 1, wherein the seal holder is formed of several parts.

11. The electrical connector according to claim 10, wherein the parts of the seal holder are movably connected with each other.

12. The electrical connector according to claim 10, wherein one or more parts of the seal holder have a recess perpendicular to the insertion direction.

13. The electrical connector according to claim 12, wherein the seal holder is arranged between a network cable such that the network cable is received the recess and another part of the seal holder is connected to a first part such that the network cable is completely surrounded by the seal holder.

14. The electrical connector according to claim 1, wherein the seal holder comprises projections in the insertion direction and/or contrary to the insertion direction.

15. A method for manufacturing a connection line for a network, comprising the steps of:
a) providing a first connector housing;
b) attaching a seal to a second side of the first connector housing;
c) providing a second connector housing with an electrically connected and mechanically attached network cable;
d) inserting the second connector housing through a seal opening into an opening of the first connector housing ;
e) moving the second connector housing until the second connector housing is received and held in a cavity of the first connector housing; and
f) attaching a seal holder to the second side of the first connector housing so that the seal is held on the first connector housing.

16. The method according to claim 15, wherein the second connector housing is completely inserted through the seal opening in method step e).

17. The method according to claim 15, wherein in method step f) further includes the substeps of:
placing part of the seal holder between the network cable; and
placing the remaining parts are placed around the network cable so that a closed surface is created through which the network cable protrudes, wherein the substeps are performed in the order recited.

18. The method according to claim 15, wherein the seal holder is attached to the first connector housing such that projections of the seal holder protrude into recesses of the seal in method step f).
